(19) United States
(12) Patent Application Publication
(10) Pub. No.: US 2025/0346456 A1
(43) Pub. Date: Nov. 13, 2025

(54) ELEVATOR SHEAVE LINER, ELEVATOR SHEAVE ASSEMBLY, AND ELEVATOR SYSTEM

(71) Applicant: Otis Elevator Company, Farmington, CT (US)

(72) Inventors: Ruguang Liu, Tianjin (CN); Guochen Gao, Tianjin (CN); Fengkun Zhu, Tianjin (CN); James Leo Hubbard, III, Kensington, CT (US)

(21) Appl. No.: 19/196,227

(22) Filed: May 1, 2025

(30) Foreign Application Priority Data
May 10, 2024 (CN) 202410578665.4

(51) Int. Cl. B66B 15/04

(52) U.S. Cl. CPC B66B 15/04

(57) ABSTRACT

An elevator sheave liner, an elevator sheave assembly and an elevator system are disclosed. The elevator sheave liner is mounted in a groove of the elevator sheave and has a first end and a second end opposite to each other, the first end is provided with an engagement portion for engagement with an elevator tension member, and the elevator sheave liner includes a first section provided on at least one side of the elevator sheave liner and abutting against a surface of the groove after the elevator sheave liner is mounted in place, a first angle is formed between the first section and a longitudinal centerline of the elevator sheave liner and the first angle is set to be not greater than arctan (μ1), μ1 is a coefficient of friction between the elevator sheave liner and the groove.

### FOREIGN PRIORITY

This application claims priority to Chinese Patent Application No. 202410578665.4, filed May 10, 2024, and all the benefits accruing therefrom under 35 U.S.C. § 119, the contents of which in its entirety are herein incorporated by reference.

### TECHNICAL FIELD OF INVENTION

The present disclosure relates to the technical field of elevators, in particular to an elevator sheave liner, an elevator sheave assembly, and an elevator system.

### BACKGROUND OF THE INVENTION

In elevator systems, power devices such as traction machines and winches are usually configured to provide power for system operation. When the elevator sheave (e.g. the traction sheave) is driven by power to rotate, it will transfer power to the elevator tension member mounted on the elevator sheave, causing the latter to start moving, thereby driving the elevator car and/or counterweight connected to the elevator tension member to move along the elevator shaft. Usually, a liner is configured on the elevator sheave to increase friction, reduce wear between components, and prolong the lifespan of components. The present disclosure has found, after research, that the elevator sheave liner in the prior art still needs to be improved in terms of structure, performance, installation, replacement and maintenance operations, manufacturing costs, and other aspects.

### SUMMARY OF THE INVENTION

In view of the foregoing, the present disclosure provides an elevator sheave liner, an elevator sheave assembly, and an elevator system, so as to solve or at least alleviate one or more of the aforementioned problems and other problems in the prior art, or to provide alternative technical solutions for the prior art.

Firstly, according to one aspect of the present disclosure, an elevator sheave liner is provided, wherein the elevator sheave liner is mounted in a groove of an elevator sheave and has a first end and a second end opposite to each other, the first end being provided with an engagement portion for engagement with an elevator tension member, the elevator sheave liner comprising: a first section provided on at least one side of the elevator sheave liner and abutting against a surface of the groove after the elevator sheave liner is mounted in place, wherein a first angle is formed between the first section and a longitudinal centerline of the elevator sheave liner and the first angle is set to be not greater than arctan (μ1), wherein μ1 is a coefficient of friction between the elevator sheave liner and the groove.

In an elevator sheave liner according to the present disclosure, optionally, the elevator sheave liner further comprises a second section connected to the first section and closer to the second end and the longitudinal centerline relative to the first section, and a second angle that is not less than the first angle is formed between the second section and the longitudinal centerline.

In an elevator sheave liner according to the present disclosure, optionally, a gap is maintained between the second section and a surface of the groove after the elevator sheave liner is mounted in place, and/or an outer surface of the second section is configured to be a planar surface, an undulating surface, and/or an arched surface.

In an elevator sheave liner according to the present disclosure, optionally, the gap ranges from 0.1 to 2 millimeters.

In an elevator sheave liner according to the present disclosure, optionally, the second angle ranges from 0.5×arctan(μ1) to 90°.

In an elevator sheave liner according to the present disclosure, optionally, the elevator sheave liner further comprises a third section provided at the second end and connected to the second section, and a gap is maintained between the third section and a bottom of the groove after the elevator sheave liner is mounted in place.

In an elevator sheave liner according to the present disclosure, optionally, the first angle ranges from 2.3° to arctan(μ1), and/or an outer surface of the first section is configured to be a planar surface, an undulating surface, and/or an arched surface.

In an elevator sheave liner according to the present disclosure, optionally, the engagement portion is configured to be a concave portion to accommodate the elevator tension member, the concave portion having protruding portions on each side thereof, the groove has an assembly portion, and when the elevator sheave liner is mounted, the protruding portions abut against the assembly portion to cause the elevator sheave liner to be mounted in place in the groove.

In an elevator sheave liner according to the present disclosure, optionally, the elevator sheave liner is configured such that F2 obtained from the following equation is not less than F1:

$$F 1 = \frac{4 \times μ1 \times ( 1 - sin \frac{θ}{2} )}{π - θ - sin θ}$$

$$F 2 = \frac{μ2}{sin \frac{γ}{2}}$$

wherein, θ is an undercut angle of the groove, γ is an angle formed by intersection of two sides of the groove after extension, and μ2 is a coefficient of friction between the elevator sheave liner and the elevator tension member.

In an elevator sheave liner according to the present disclosure, optionally, the elevator sheave liner is integrally formed and mounted in the groove, or the elevator sheave liner is configured to comprise two or more combinable portions, the combinable portions being mounted in the groove after combination.

In an elevator sheave liner according to the present disclosure, optionally, a seam between two adjacent portions of the combinable portions is configured in a shape of a step, an arc, or an oblique line forming an angle of less than 90° and not less than 10° with a longitudinal section of the elevator sheave.

In addition, according to another aspect of the present disclosure, an elevator sheave assembly is also provided, which comprises: an elevator sheave configured with one or more grooves along its circumference; and one or more elevator sheave liners according to any of the above, wherein each of the elevator sheave liners is mounted correspondingly in one of the grooves.

Furthermore, according to another aspect of the present disclosure, an elevator system is further provided, which comprises: a power device configured to provide power; and an elevator car operating between elevator landings under the power; and an elevator tension member and an elevator sheave assembly according to any of the above, wherein the elevator sheave is connected to a power output end of the power device, and the elevator tension member is engaged with the engagement portion of the elevator sheave liner and connected to the elevator car to transmit the power to the elevator car.

In an elevator system according to the present disclosure, optionally, the power device includes a traction machine and a winch, and/or the elevator tension member includes a steel belt and a rope.

An elevator sheave liner can be effectively prevented from slipping, loosening or falling off from the elevator sheave, by adopting an optimized structural design according to the present disclosure. Therefore, the problems of increased frictional loss and further wear caused by the movement of the elevator sheave liner can be solved, and the safety performance of an elevator system can be significantly improved. Compared with the prior art, structures such as the elevator sheave liner and the groove of the elevator sheave in the solutions according to the present disclosure are easy to process, require shorter manufacturing and installation time, and have simple and convenient installation operations, which can significantly reduce the workload of on-site personnel and reduce overall costs.

### BRIEF DESCRIPTION OF THE DRAWINGS

The technical solutions of the present disclosure will be described in further detail below with reference to the accompanying drawings and embodiments. However, it should be understood that these drawings are designed merely for the purpose of explanation and only intended to conceptually illustrate the structures and configurations described herein, and are not required to be drawn to scale.

FIG. 1 is a three-dimensional structural schematic diagram of an example of an elevator system that can adopt various embodiments of the present disclosure.

FIG. 2 is a schematic diagram of a side sectional structure of an embodiment of an elevator sheave liner according to the present disclosure, where partial side sectional structure of an example of an elevator tension member and an example of an elevator sheave are also shown.

FIG. 3 is a schematic diagram of the curve relationship between the self-locking angle and the coefficient of friction μ1 of another embodiment of an elevator sheave liner according to the present disclosure.

FIG. 4 is a schematic diagram of the structural stress analysis of yet another embodiment of an elevator sheave liner according to the present disclosure and an example of an elevator sheave during use.

FIG. 5 is a three-dimensional structural schematic diagram of still another embodiment of an elevator sheave liner according to the present disclosure mounted on an example of an elevator sheave.

FIGS. 6(a)-6(d) show the respective local top-view structural schematic diagrams in which four different embodiments of an elevator sheave liner according to the present disclosure are respectively mounted onto an example of an elevator sheave.

### DETAILED DESCRIPTION OF THE INVENTION

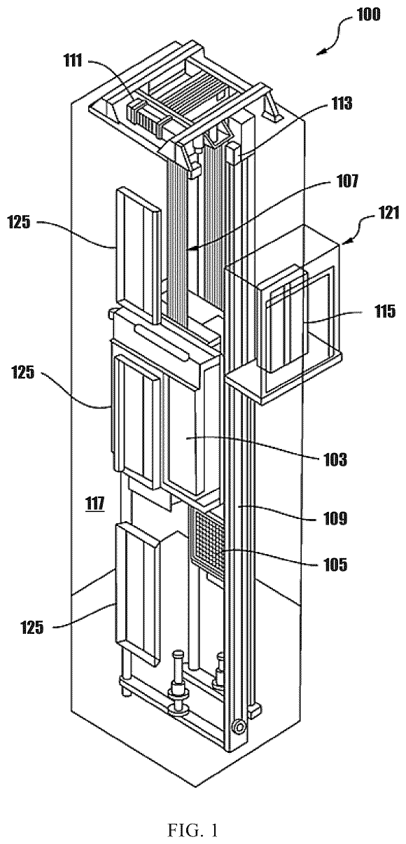

FIG. 1 is a perspective view of an elevator system 100 including an elevator car 103, a counterweight 105, a tension member 107, a guide rail (or rail system) 109, a machine (or machine system) 111, a position reference system 113, and an electronic elevator controller (controller) 115. The elevator car 103 and counterweight 105 are connected to each other by the tension member 107. The tension member 107 may include or be configured as, for example, steel belts (e.g. coated-steel belts) and/or ropes (e.g. steel cables). The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 100. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown in FIG. 1, in a controller room 121 of the elevator shaft 117 and is configured to control the operation of the elevator system 100, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. At this point, the passengers can get in or out of the elevator car 103 through the opened elevator landing door. Although shown in a controller room 121, those of skill in the art will appreciate that the controller 115 can be located and/or configured in other locations or positions within the elevator system 100. In one embodiment, the controller may be located remotely or in the cloud.

The machine 111 may include a motor or similar driving mechanism to provide operating power to elevator system 100, and such elevator driving devices are often referred to as traction machines, winches, etc. in practical applications. In accordance with embodiments of the present disclosure, the machine 111 can be configured to include an electrically driven motor. The power supply for the motor may be any power source, including a power grid, which, in combination with other components, is supplied to the motor. The machine 111 may include an elevator sheave 20, which may be used as, for example, a traction sheave that imparts force to tension member 107 to move the elevator car 103 within elevator shaft 117 to reach the desired elevator landing 125.

Although specific elevators and components are shown and described herein, FIG. 1 is merely a non-limiting example presented for illustrative and explanatory purposes. It should be noted that other elevator systems can be configured to use the elevator sheave liner and elevator sheave assembly disclosed herein. Additionally, for the sake of simplification, identical or similar components and features may only be indicated in one or several locations within the same drawing. Technical terms such as “first” and “second” are only used for the purpose of distinguishing and are not intended to indicate the order and relative importance thereof. The technical term “connect” (or “engage”) means the realization of connection (or engagement) in a direct or an indirect manner.

As used herein, in various embodiments, as shown in FIG. 2, one or more grooves 21 may be arranged as needed on an elevator sheave 20. The groove(s) 21 may be arranged along the circumference of the elevator sheave 20, and an elevator sheave liner 10 can be correspondingly configured in the groove(s) 21 to increase friction, reduce component wear, reduce vibration, and prolong service life. In particular, the elevator sheave liner 10 can achieve the self-locking and anti-slip functions. The elevator sheave liner 10 may generally be made of suitable non-metallic materials such as rubber, and be constructed with opposite ends 10a and 10b, wherein an engagement portion 14 may be provided at the end 10a to engage with a tension member 107. For example, the engagement portion 14 may be configured with a concave structure to accommodate the tension member 107 when in use. The tension member 107 is in contact with the elevator sheave liner 10 and, under the power from the machine 111 transmitted by the elevator sheave 20, it will drive the elevator car 103 to move along the guide rail 109 to reach the target landing.

The elevator sheave liner 10 may be configured with a first section 11, a second section 12, and a third section 13. The first section 11 may be arranged on both sides of the elevator sheave liner 10, and the second section 12 may also be arranged on both sides of the elevator sheave liner 10 and connected to the first section 11. The second section 12 is closer to the longitudinal centerline L and the end portion 10b of the elevator sheave liner 10 relative to the first section 11. The third section 13 is arranged at the end portion 10b to connect the second section 12 located on both sides of the elevator sheave liner. The third section 13 may be configured to be needed to have a suitable configuration with a planar, circular arc or any other shape. Generally speaking, the longitudinal centerline L of the elevator sheave liner 10 is perpendicular to the rotation axis of the elevator sheave 20. As used herein, in various embodiments, by constructing, for example, protruding portions 15 on both sides of the engagement portion 14 on the elevator sheave liner 10, the protruding portions 15 can correspondingly abut against an assembly portion 22 of the groove 21 of the elevator sheave 20 when mounting the elevator sheave liner 10, so that the elevator sheave liner 10 can be stably assembled onto the elevator sheave 20.

After the elevator sheave liner 10 is mounted in place on the elevator sheave 20, as used herein, in various embodiments, the first section 11 will abut against the surface of the groove 21, and an angle α will be formed between the first section 11 and the longitudinal centerline L. According to the technical solutions of the present disclosure, when the angle α is set to be less than or equal to arctan (μ1) (μ1 is the coefficient of friction between the elevator sheave liner 10 and the groove 21), for example, by setting the angle α to range from 2.3° to arctan (μ1), the elevator sheave liner 10 can be kept in its current position without easily slipping, loosening, or falling off from the elevator sheave 20, thereby effectively avoiding adverse consequences caused by the above problems, such as increase in friction loss and vibration, generation of more wear, and adverse effect on the safe operation of the elevator.

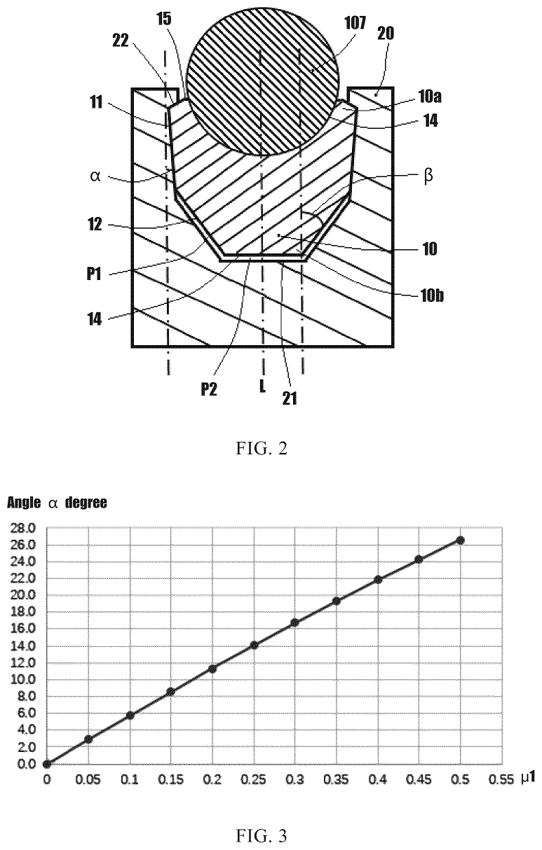

As an example, FIG. 3 schematically illustrates the curve relationship between the self-locking angle and the coefficient of friction μ1 of an embodiment of an elevator sheave liner. The horizontal axis in the figure represents the coefficient of friction μ1 between the elevator sheave liner and the groove of the elevator sheave, and the vertical axis represents the calculated value of the arctangent function of μ1, i.e., arctan (μ1). The graph is divided into two areas along the curve shown in FIG. 3, namely the non-self-locking area located in the upper part and the self-locking area located in the lower part. When the angle α of the first section of the elevator sheave liner is designed to be within the lower self-locking area corresponding to the current μ1, the elevator sheave liner can maintain a self-locking state on elevator sheave 20, making it less likely to slip, loosen, or fall off from the elevator sheave 20. For example, when μ1−0.25, then α=14.04°, the angle α of the first section may be designed not to exceed 14.04° at this point, so that the elevator sheave liner can tend to maintain self-locking in the current position after being mounted in place on the elevator sheave 20.

As used herein, in various embodiments, as shown in FIG. 2, the second section 12 of the elevator sheave liner 10 may be configured to form an angle β with respect to the longitudinal centerline L. The angle β is generally greater than or equal to the above-mentioned angle a, thereby preventing relative sliding of the elevator sheave liner 10. As an optional scenario, the angle β may be selected to range from 0.5×arctan (μ1) to 90°. At this point, the second section 12 is closer to the longitudinal centerline L of the elevator sheave liner 10 relative to the first section 11. That is, the elevator sheave liner 10 presents a gradually shrinking configuration from end 10a to end 10b, which will make it easier for processing and assembling and disassembling operations.

As used herein, in various embodiments, the second section 12 may be optionally configured such that, after the elevator sheave liner 10 is mounted in place, a gap P1 is maintained between the second section 12 and the surface of the groove 21, and/or a gap P2 is maintained between the third section 13 and the bottom of the groove 21. The specific setting values of the gaps P1 and P2 above may be flexibly configured according to actual application needs. For example, P1 may be set to range from 0.1 to 2 millimeters, P2 may be set to not exceed 1 millimeter, and the like. The present disclosure does not make any restrictions in this regard.

By adopting the above structural design, the elevator sheave liner 10 may have a tendency to move downwards during use, i.e., tend to move towards the bottom of the groove 21. This will effectively prevent the elevator sheave liner 10 from slipping, loosening or falling off from the elevator sheave 20, facilitates the elevator sheave liner 10 to maintain sufficient contact with the groove 21, and ensure and enhance the close contact between the elevator sheave liner 10 and the elevator sheave 20 and the tension member 107, thus ensuring long-term stable operation.

By virtue of the combined design of combining the angle α of the first section 11 with the angle β of the second section 12, not only can the self-locking and anti-slip functions of the elevator sheave liner 10 be better achieved, but it can also have advantages over technical solutions of the prior art, such as the dovetail groove structure commonly used by elevator sheaves. The elevator sheave liner and its matching elevator sheave groove have advantages such as easy processing, manufacturing, installation, disassembly and maintenance, and stable working performance.

As used herein, in various embodiments, the elevator sheave liner 10 may adopt a bilaterally symmetrical structural design. Of course, in one or some embodiments, the elevator sheave liner 10 may also adopt an asymmetric design. For example, the first section is only arranged on one side of the elevator sheave liner 10, or two asymmetric first sections are arranged on both sides, such as using angles a that are different from each other. In addition, in one or some embodiments, the second section 12 and/or the third section 13 may be removed as needed according to actual circumstances. Furthermore, it should be appreciated that for the first section 11 and the second section 12, it is allowed to construct them towards the surface of the groove 21 into a planar surface, undulating surface, and/or arched surface as needed, and the groove 21 may also optionally have a matching configuration accordingly. In cases where the first section 11 and/or the second section 12 may have relatively complex surfaces, such relatively complex surfaces may be equivalently treated as basic planes. For example, the angle of each planar surface section in the undulating surface may be set to conform to the corresponding design of the present disclosure regarding angle a or angle β. For another example, the arched surface may be approximated into several undulating surfaces and then subjected to angle design processing according to the above method.

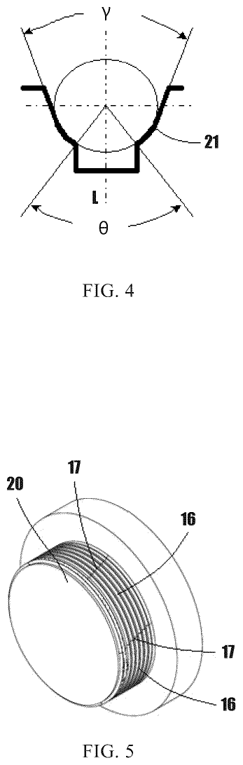

With continued reference to FIG. 4, it only illustrates, as an example, the states of stress based on the structure of an example of an elevator sheave. When the example of an elevator sheave is used in conjunction with an embodiment of an elevator sheave liner according to the present disclosure, the elevator sheave liner 10 may be optimized according to the following two equations:

$$F 1 = \frac{4 \times μ1 \times ( 1 - sin \frac{θ}{2} )}{π - θ - sin θ}$$

$$F 2 = \frac{μ2}{sin \frac{γ}{2}}$$

wherein, in the above equation, F1 is the friction force between the tension member 107 and the elevator sheave liner 10, F2 is the friction force between the elevator sheave liner 10 and the groove 21, μ1 is the coefficient of friction between the elevator sheave liner 10 and the groove 21, μ2 is the coefficient of friction between the tension member 107 and the elevator sheave liner 10, θ is the undercut angle of the groove, and γ is an angle formed by the intersection of the two sides of the groove 21 after extension.

By optimizing the selection for materials respectively used for the elevator sheave liner, elevator sheave, and tension member (i.e., select to design μ1 and μ2), as well as β and γ, it is possible to achieve F2 not less than F1, which means that the friction force between the elevator sheave liner 10 and the groove 21 is greater than or equal to the friction force between the elevator sheave liner 10 and the tension member 107. Therefore, at this point, it is not possible or is not easy to cause the elevator sheave liner to slip, loosen, or fall off from the elevator sheave 20.

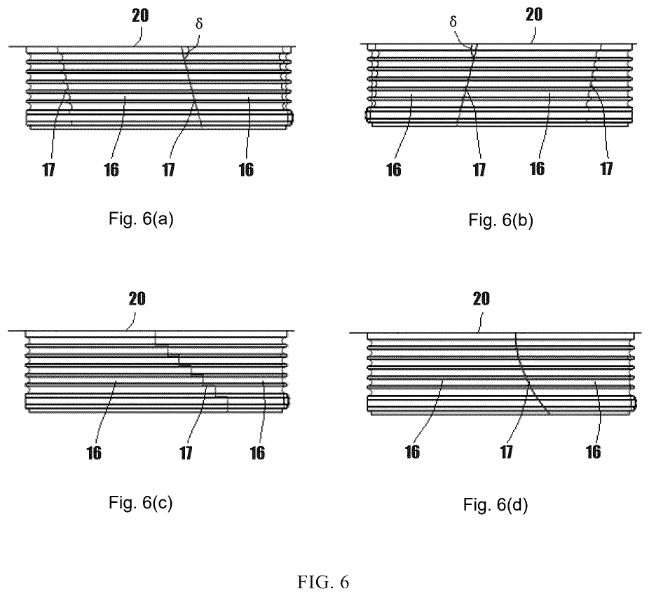

In one or some embodiments, the elevator sheave liner 10 can be integrally formed (e.g. using injection technology, etc.) and then mounted as a whole into the groove 21 of the elevator sheave 20. However, in another or some embodiments, the elevator sheave liner 10 may be configured to comprise two or more combinable portions as needed, and these combinable portions can be assembled and then mounted into the groove 21 of the elevator sheave 20 during use. These combinable portions are schematically marked with reference numerals 16 in FIGS. 5 and 6. Similarly, the elevator sheave 20 may have an integrated structure or a split-type assembly structure, which may be made using suitable processes such as integral casting or machining. In addition, as an optional scenario, additionally configured metal parts may be mounted in a detachable manner on the body of the elevator sheave 20 as grooves for use in conjunction with the elevator sheave liner 10. As such, even in extreme cases where the elevator sheave liner 10 is completely worn out, the structures of the above metal parts may be used to bear the traction force of the system, and then the damaged elevator sheave liner 10 may be replaced at an appropriate time. This is beneficial for reducing system downtime, reducing overall service costs, prolonging the service life of components such as elevator tension members, and effectively enhancing the safety performance of the elevator system.

In the embodiment of FIG. 5, it only illustrates, as an example, that the elevator sheave liner 10 may have several combinable portions 16. These portions may have the same or different structural configurations in terms of circumferential length, edge contour, material and color selection. For example, the seam 17 of two assembled adjacent combinable portions 16 of the elevator sheave liner 10 may be configured into any suitable shape as needed. For example, in FIGS. 6(a)-6(d), seam configurations such as oblique line shape (FIGS. 6(a) and 6(b)), stepped shape (FIG. 6(c)), and circular arc shape (FIG. 6(d)) are shown respectively. FIGS. 6(a) and 6(b) also show that such oblique lines may have different tilt directions relative to the axis of the elevator sheave 20. For example, optionally, the oblique line may be configured to form an angle δ relative to the longitudinal section of the elevator sheave 20, where the angle δ is greater than or equal to 10° and less than 90°. In the case where the seam 17 between two adjacent combinable portions 16 has a seam configuration that is not parallel to the axis of the elevator sheave 20, this will result in a contact time difference between the elevator tension member 107 and different seam parts, thereby effectively reducing or avoiding adverse effects such as vibration and noise that may be caused by the elevator tension member 107 when coming into contact with the seam 17.

It should be appreciated that the present disclosure allows for flexible configuration according to actual application requirements in terms of the specific number of combinable portions 16 configured for the elevator sheave liner 10, the configuration settings of a single combinable part, and the matching settings between respective combinable portions, where no restrictions are made in this regard.

According to the solutions of the present disclosure, an elevator sheave assembly is also provided, which is configured with an elevator sheave and one or more elevator sheave liners according to the present disclosure that are correspondingly arranged on the groove of the elevator sheave. As the elevator sheave liner therein has the obvious advantages of, for example, self-locking and anti-slip, easy processing and manufacturing, easy assembly and maintenance, low application cost, and high reliability, the elevator sheave assembly is applicable to a wide range of elevator systems. This helps to ensure the long-term stable operation of the elevator system and improve system safety performance.

An elevator sheave liner, an elevator sheave assembly, and an elevator system according to the present disclosure have been described above in detail by way of examples only. These examples are merely used to illustrate the principles and embodiments of the present disclosure, rather than limiting the present disclosure. Various modifications and improvements can be made by those skilled in the art without departing from the scope of the present disclosure. Therefore, all equivalent technical solutions should fall within the scope of the present disclosure and be defined by the claims of the present disclosure.

What is claimed is:

1. An elevator sheave liner, wherein the elevator sheave liner is mounted in a groove of an elevator sheave and has a first end and a second end opposite to each other, the first end being provided with an engagement portion for engagement with an elevator tension member, the elevator sheave liner comprising:
a first section provided on at least one side of the elevator sheave liner and abutting against a surface of the groove after the elevator sheave liner is mounted in place, wherein a first angle is formed between the first section and a longitudinal centerline of the elevator sheave liner and the first angle is set to be not greater than arctan (μ1), wherein μ1 is a coefficient of friction between the elevator sheave liner and the groove.

2. The elevator sheave liner according to claim 1, wherein the elevator sheave liner further comprises a second section connected to the first section and closer to the second end and the longitudinal centerline relative to the first section, and a second angle that is not less than the first angle is formed between the second section and the longitudinal centerline.

3. The elevator sheave liner according to claim 2, wherein a gap is maintained between the second section and a surface of the groove after the elevator sheave liner is mounted in place, and/or an outer surface of the second section is configured to be a planar surface, an undulating surface, and/or an arched surface.

4. The elevator sheave liner according to claim 3, wherein the gap ranges from 0.1 to 2 millimeters.

5. The elevator sheave liner according to claim 2, wherein the second angle ranges from 0.5×arctan(μ1) to 90°.

6. The elevator sheave liner according to claim 2, wherein the elevator sheave liner further comprises a third section provided at the second end and connected to the second section, and a gap is maintained between the third section and a bottom of the groove after the elevator sheave liner is mounted in place.

7. The elevator sheave liner according to claim 1, wherein the first angle ranges from 2.3° to arctan(μ1), and/or an outer surface of the first section is configured to be a planar surface, an undulating surface, and/or an arched surface.

8. The elevator sheave liner according to claim 1, wherein the engagement portion is configured to be a concave portion to accommodate the elevator tension member, the concave portion having protruding portions on each side thereof, the groove has an assembly portion, and when the elevator sheave liner is mounted, the protruding portions abut against the assembly portion to cause the elevator sheave liner to be mounted in place in the groove.

9. The elevator sheave liner according to claim 1, wherein the elevator sheave liner is configured such that F2 obtained from the following equation is not less than F1:
$$F 1 = \frac{4 \times μ1 \times ( 1 - sin \frac{θ}{2} )}{π - θ - sin θ}$$
$$F 2 = \frac{μ2}{sin \frac{γ}{2}}$$
wherein, θ is an undercut angle of the groove, γ is an angle formed by intersection of two sides of the groove after extension, and μ2 is a coefficient of friction between the elevator sheave liner and the elevator tension member.

10. The elevator sheave liner according to claim 1, wherein the elevator sheave liner is integrally formed and mounted in the groove, or the elevator sheave liner is configured to comprise two or more combinable portions, the combinable portions being mounted in the groove after combination.

11. The elevator sheave liner according to claim 10, wherein a seam between two adjacent portions of the combinable portions is configured in a shape of a step, an arc, or an oblique line forming an angle of less than 90° and not less than 10° with a longitudinal section of the elevator sheave.

12. An elevator sheave assembly, comprising:
an elevator sheave configured with one or more grooves along its circumference; and
one or more elevator sheave liners according to claim 1, wherein each of the elevator sheave liners is mounted correspondingly in one of the grooves.

13. An elevator system, comprising:
a power device configured to provide power; and
an elevator car operating between elevator landings under the power; and
an elevator tension member, and an elevator sheave assembly according to claim 12, wherein the elevator sheave is connected to a power output end of the power device, and the elevator tension member is engaged with the engagement portion of the elevator sheave liner and connected to the elevator car to transmit the power to the elevator car.

14. The elevator system according to claim 13, wherein the power device includes a traction machine and a winch, and/or the elevator tension member includes a steel belt and a rope.
